(19) United States
(12) Patent Application Publication
(10) Pub. No.: US 2023/0274328 A1
(43) Pub. Date: Aug. 31, 2023

(54) DEVICE FOR TRIGGERING A PROCESS

(71) Applicant: YOUGIVER AG, Rotkreuz (CH)

(72) Inventor: Oleksandr KONOVALOV, Steinhausen (CH)

(73) Assignee: YOUGIVER AG, Rotkreuz (CH)

(21) Appl. No.: 18/007,907

(22) PCT Filed: Jun. 2, 2020
(86) PCT No.: PCT/EP2020/065187

§ 371 Date: Dec. 2, 2022

(51) Int. Cl. G06Q 30/0601; G06Q 50/00

(52) U.S. Cl. CPC G06Q 30/0615; G06Q 30/0609; G06Q 50/01

(57) ABSTRACT

A computing device for triggering a process comprises a control unit which is configured to perform the following steps: Receiving a request signal from a first remote computing device, the request signal requesting the triggering of the process, including a first identifier representing a registered user of a digital communication platform, and including a second identifier representing another registered user of the digital communication platform; Retrieving from a database a set of database entries subject to location data or a subset thereof assigned to the second identifier; Transmitting a response signal to the first remote computing device, the response signal including the retrieved set of database entries; Receiving a confirmation signal from the first remote computing device, the confirmation signal including a database entry selected from the retrieved set of database entries; and Transmitting a trigger signal to a second remote computing device assigned to the selected database entry, for triggering the process, the trigger signal including the selected database entry and the location data.

### TECHNICAL FIELD

The present invention relates to a computing device for triggering a process as well as to a corresponding system and a corresponding method.

### BACKGROUND ART

Typically, a giver can only send an object to a presentee if he knows an address of the presentee, i.e. is the place where the object is to be delivered. When the object and the presentee's address are provided, the process of delivery itself may be executed by a delivery service.

A problem, however, arises frequently if the giver does not know the presentee's address. This problem arises all the more if the giver and the presentee are in contact mainly via online services such as a communication platform, e.g. a social media platform or a messenger. Usually, there is no need that users of a communication platform exchange their addresses. Often, it is even undesired that users of a communication platform know the addresses of other users, e.g. for reasons of privacy. In that case, a first user, i.e. the giver, cannot send a gift to a second user, i.e. the presentee, in a simple manner.

### DISCLOSURE OF THE INVENTION

Hence, it is a general object of the invention to provide a computing device and a computer-implemented method which allow the delivery of a gift from a giver to a presentee without the sender knowing location data of the presentee.

Now, in order to implement these and still further objects of the invention, which will become more n readily apparent as the description proceeds, a first object of the invention relates to a computing device for triggering a process, which process in particular is the delivery of a gift to the presentee. The computing device, or short device, comprises a control unit and may e.g. be a server, server farm, or server system of a service provider, in particular a virtual server, providing “the service”. The control unit is configured to receive a request signal from a first remote computing device, in particular from a computing device used by the giver, e.g. a computer or smartphone, and/or from a server of a digital communication platform used by the giver. In particular, the digital communication platform offers the request in form of a web link within its application to the user who runs the app representing the communication platform on his remote computing device such as a smartphone, to which the user preferably is logged on. The request signal requests the triggering of the process, optionally includes a first identifier representing the giver as a registered user of a digital communication platform, and includes a second identifier representing another registered user of the digital communication platform, in particular representing the presentee. The digital communication platform may e.g. be a social media platform or a messenger, such as Facebook™, Whatsapp™, or a dating platform such as Tinder™ etc.

It is preferred that the user triggers the request signal within the environment of the digital communication platform, hence at a time when being logged in. It is understood, that when triggering the request signal by the user, in one alternative a direct connection outside the communication platform may be established between the first remote computing device assigned to the user and the present computing device. However, in a different and more preferred embodiment as indicated n above, the triggering of the request at the first computing device may be effected from within the communication platform to the computing device, such that the server system of the communication platform appears as sender of the request signal after being initiated by the user on the first remote computing device. In this scenario, the first remote computing device maybe rather be represented by the server system representing the communication platform on which the user triggers the request signal, by means of his/her physical computing device such as a smartphone.

This may apply in the same way to any communication between the computing device and the user and/or the other user.

Hence, it is preferred that the communication between the user and the computing device, and/or the communication between the other user and the computing device is established via and through the communication platform, in particular when only the identifiers for the communication platforms are known to the computing device. Accordingly, the communication platform preferably is approached by the computing device, and notifications are sent to the communication platform in combination with the first and/or the second identifier as final addressee. Such notification may then trigger the communication platform to forward the notification to the user or other user represented by the first or the second identifier within the communication platform. However, such notifications are received or called by the user or other user on their remote first or second computing devices respectively when operating the app representing the communication platform. In addition, it is understood that, that if the first remote computing device is assigned to the user/giver and the second remote computing device is assigned to other user/the presentee, i.e. is in their possession, those computing devices are preferably considered as representatives of any other n physical remote computing devices the particular user may have and use to log on the communication platform or the service providers servers.

Specifically, the request, presented to the user within the communication platform he/she is logged onto, is represented by a HTTP POST request calling the computing device when activated/clicked, specifically calling a web address of the computing device. The request preferably includes as parameters at least an identifier of the communication platform, i.e. an identifier by which the computing device identifies the communication platform amongst other communication platforms, and the second identifier, i.e. the identifier of the other user of the communication platform acting as presentee. It is preferred, that the user selects the corresponding person from a contact book of the communication platform, and the communication platform may automatically add the corresponding identifier as second identifier to the HTTP POST request, see above.

In addition, such request preferably includes the first identifier representing the user in the communication platform, and possibly other data such as the users email, phone number etc. In a further embodiment, the request may in addition to the second identifier include a country and a city of residence of the other registered user. Again, it is preferred, that the user may select the corresponding person from a contact book, and the communication platform may automatically add the corresponding country and city to the HTTP POST request, see above.

A possible answer format triggered by the request may be in JSON and may provide a URL the user is to follow.

Further, the control unit is configured to retrieve from a database a set of database entries subject to location data or a subset thereof assigned to the n second identifier. Each database entry may represent a gift which is available through a seller for delivery within a certain area, e.g. in a specific country. For the subset of the location data, it may thus be sufficient to include a country, or a country and a city, or a country and a region.

Further, the control unit is configured to transmit a response signal to the first remote computing device. The response signal includes the retrieved set of database entries. Further, the control unit is configured to receive a confirmation signal from the first remote computing device. The confirmation signal includes a database entry selected from the retrieved set of database entries. In particular, the confirmation signal includes the database entry selected by the registered user, i.e. the giver.

Moreover, the control unit is configured to transmit a trigger signal to a second remote computing device assigned to the selected database entry, for triggering the process. The second remote computing device may be the server or any other system of the seller. The trigger signal includes the selected database entry and the location data. The location data advantageously comprises a complete specification of a physical address, in particular enabling delivery of the gift. On the basis of the trigger signal, the seller will advantageously deliver the gift represented by the selected database entry to the presentee's address represented by the location data.

Hence the device facilitates the triggering of the process without the giver needing to know the address of the presentee. This is particularly advantageous when the giver and the presentee are users of a digital communication platform who mainly communicate through the communication platform. Also, it may be advantageous if the presentee wants to keep her address for herself, e.g. n for reasons of privacy or precaution.

Another advantage of such device is that the set of database entries is compiled depending on the location data. Thus, the giver only needs to select from a set of gifts which are effectively deliverable to the address of the presentee, which improves the user-friendliness of the service. Further, this helps to save costs and the environment by favoring local sellers and reducing delivery distances. For sellers such as a flower bouquet manufacturer, in turn, the device and service opens up a whole new market of givers that previously were not able to send a gift to the presentee.

In an advantageous embodiment, the control unit is configured to receive the request signal additionally including the location data or a subset thereof assigned to the second identifier. This may be the case if the location data or the subset thereof is available in the digital communication platform, e.g. via an address book of the communication platform which may be private and only visible to the corresponding user of the communication platform. In that case, the giver may trigger the service by initiating the request signal which then includes the second identifier without any location data assigned. In that case, and under the assumption that the request signal is triggered by the giver in the communication platform, the communication platform, in particular its server system or other computing structure, may automatically add the location data assigned to the second identifier to the request such that the request signal that is sent to the server representing the service includes not only the second identifier but also the assigned location data. Accordingly, the location data assigned to the second identifier remains invisible to the giver, but is automatically included into the request signal triggered by the giver, which is sent to the n server.

Once a request signal including location data assigned to the second identifier is received by the server, its control unit advantageously is configured to, in response to receiving the request signal, retrieve the set of database entries from the database subject to the location data comprised in the request signal. Such automatic inclusion of location data in the request signal makes it superfluous that the presentee registers her address anew. Instead, the location data available e.g. through the digital communication platform is used, which makes the device and service user-friendly.

In a different embodiment, there is no location data included in the request signal submitted to the server, be it directly from the giver or from the communication platform. Hence, the server may only be aware of the second identifier with respect of the presentee, without having any location data of this person yet. Then, in one embodiment, the control unit may be configured to search e.g. a register of the service implemented in the server for an entry corresponding to the second identifier. The person represented by the second identifier may already be registered for the service offered by the server, such that the request signal including the second identifier but no location data assigned thereto may be sufficient to trigger the process. However, in this case, it is preferred that the server maintains a mapping table for mapping the second identifier, which represents the presentee in a format used in the communication platform, to a profile in a format as used in the server for providing the services. Such profile may then include the location data of this person, such that the process can be triggered.

In another embodiment—again in the scenario where the request signal is absent any location data assigned to the second identifier, the control unit is configured to transmit a counter request signal to the first n remote computing device in response to receiving the request signal. The counter request signal requests for the location data or a subset thereof assigned to the second identifier. This may be useful if the giver knows the address or part of the address, e.g. the city, of the presentee. The control unit is then further configured to receive location confirmation signal from the first remote computing device. The location confirmation signal includes the location data or the subset thereof assigned to the second identifier. Further, the control unit is configured to retrieve the subset of database entries from the database in response to the location confirmation signal received from the first remote computing device. This means that the subset of database entries presented to the giver for a selection is compiled dependent on the location data provided by the giver.

In a further embodiment, either no location data for the second identifier, or only part of the presentee's address, i.e. a subset of location data, may be available through the giver and/or the digital communication platform for whatever means. E.g. a policy of the communication platform may not allow to share location data with a third party, or it is not envisaged to ask the giver for the presentee's location data under the assumption that this is not known to the giver when making use of the service. This means that the request signal or the location confirmation signal only includes the subset of location data or no location data, and in particular a further part of the location data needs to be asked for from the presentee. In addition, the presentee may not be registered yet with the service, or the second identifier cannot be mapped to a registered profile of the service for other reasons. In that case, the control unit is configured to transmit a notification signal to a server computing system representing the communication platform in response to receiving the confirmation signal. The notification signal includes the second identifier, and requests the server computing system to present an additional location data request to the second identifier. Advantageously, the notification signal includes triggering the server computing system to automatically present the additional location data request to the second identifier, i.e. to the presentee. Further, the control unit is configured to receive an additional signal from a third remote computing device, in particular from the presentee's computing device either directly when e.g. already registered, or otherwise via communication platform as is explained above. The additional signal includes the additional location data. In response to receiving the additional signal, the control unit is configured to transmit the trigger signal to the second computing device.

In a particular embodiment, the additional location data request in the notification signal includes a web link to a web address of the device. Such link sent from the provider of the device to the communication platform in order to be presented to the presentee is a simple way of implementing the request for additional location data into the communication platform.

An advantageous embodiment refers to the communication between the device and the giver through the digital communication platform. In that case, the control unit is configured to transmit a notification signal to a server computing system representing the communication platform. The notification signal includes the first identifier, and requests the server computing system to present a predefined request to the first identifier. Preferably, the notification signal includes triggering the server computing system to automatically present the predefined request to the first identifier. Advantageously, the predefined request in the notification signal includes a web link to a web address of the device.

Such implementation of the communication n makes it possible that the giver may use the service of the device′ provider, i.e. he may trigger the process of delivery, without the need to install a dedicated app or program and even without the need to visit a separate website. Instead, the giver may trigger the process from within the digital communication platform, e.g. in the corresponding app on his smartphone. This saves time for the giver and again makes the whole service user-friendly.

A further advantageous embodiment refers to the communication between the device and the presentee through the digital communication platform. In that case, the control unit is configured to transmit a notification signal to a server computing system representing the communication platform. The notification signal includes the second identifier, and requests the server computing system to present a predefined request to the second identifier. Preferably, the notification signal includes triggering the server computing system to automatically present the predefined request to the second identifier. Advantageously, the predefined request includes a web link to a web address of the device.

In analogy to the above, such implementation of the communication makes it possible that the presentee may use the service of the device′ provider, i.e. she may e.g. provide further location data or accept the delivery of the gift, without the need to install a dedicated app or program and even without the need to visit a separate website. This, again, makes the service user-friendly. Moreover, it increases the presentee's trust in the service, e.g. in that her address is not made available to the giver for the purpose of gift delivery.

In an embodiment, the digital communication platform allows digital communication between registered users by means of identifiers representing the registered users. The device advantageously comprises a memory for storing identifiers of registered communication platforms. The request signal includes an identifier for the communication platform the user makes use of when initiating the request signal. Thus, the provider of the device and of the service knows from which communication platform a request has been sent. This enables an attribution of delivery processes to the respective communication platform, e.g. for accounting and billing purposes.

In particular, the control unit is configured to store a combination of the identifier of the communication platform, the first identifier and the second identifier. Further, the control unit is advantageously configured to assign a processing identifier representing the requested process to at least the combination of the identifier of the communication platform, the first identifier and the second identifier, and to store the processing identifier, which e.g. may be an order number for the respective delivery process.

Further, it is advantageous that the control unit is configured to assign and store the location information in combination with the second identifier. This makes the triggering of the process simpler when it is performed repeatedly. In that way, the presentee e.g. does not have to fill in or to complete the location data several times when receiving several gifts.

In an embodiment, the first identifier represents an originator of the request signal as identified in the digital communication platform and at the same time represents the user of the first remote computing device at the time the request signal is initiated. This means that the user of the first remote computing device is identified with the giver. Such attribution makes sense in order to simplify triggering the process, and thus to make it more user-friendly. Further, the second identifier advantageously represents a recipient, i.e. the presentee, of the triggered process as identified in the digital communication platform.

In an advantageous embodiment, the control unit is configured to ban the location information to become retrievable or visible to the user represented by the first identifier, i.e. the giver. In particular, the control unit is configured not to transmit the location n information to the user represented by the first identifier. Preferably, the same is true for other personal or sensitive information such as real name, phone number, email address or other information.

According to an embodiment, the device is another server computing system, and in particular includes a web server computing system. In particular, the device is a server computing system operated by the service provider. The control unit of the device advantageously includes one or more hardware processors and software configured to implement the assigned functions. The request signal may be a hypertext transfer protocol (HTTP) message according to the POST method, in one embodiment. This or other inter-server communication allow the transmission and further integration of messages or content from the server computing system of the service provider to the communication platform represented by the other server computing system. In particular, the first identifier and/or the second identifier are comprised in the body of the message. Since this is a standardized format, the implementation of the communication with the digital communication platform is simplified, and the implementation cost for a developer of the communication platform is low.

In an advantageous embodiment, the control unit is configured to transmit the or any notification signal to the communication platform for triggering the communication platform to forward and/or display a message contained in the notification to the first identifier and/or the second identifier as recipient, as is n defined in the notification. A means for this kind of communication, for the service provider's server computing system to reach the users of the communication platform through this communication platform and its server computing system, preferably is WebHooks. In particular, a WebHook is a URL specifying the URL end-point in the communication platform, e.g. in a messenger app representing the communication platform, to which the service running on the computing device, aka as app, should send notifications to. The WebHook preferably is defined in a profile or account of the service provider running the computing device. Each communication platform may be identified in the service by a platform identifier, e.g. assigned by the computing device representing the service. Accordingly, an administrator of the communication platform may enter the platform specific URL end-point, where all communication from the service can be received in the communication platform, into a profile maintained by the service/computing device. As the service may serve many different communication platforms, there may not only be many different platform identifier stored, but also different WebHooks associated with these different platform identifiers.

In such profile any notification envisaged to be received by the communication platform on behalf of its users may be stored. A notification out of e.g. a set of predefined notifications may be selected for each WebHook sent. The set of predefined notifications may vary between different WebHooks, i.e. between the registered communication platforms.

E.g. in case the request received by the service includes an identifier of the communication platform it was triggered at, the computing device may have stored a set of notifications agreed with this communication platform. Subject to an event, status or other trigger, and/or subject to a determined process flow for the communication with the communication platform, the control unit of the computing device may automatically select the appropriate notification available for the WebHook assigned for this communication platform, and automatically transmits the platform specific WebHook generated in this way to the communication platform. The respective communication platform receives this signal and automatically transmits e.g. a message included in the notification to the user or to other user registered with the communication platform subject to the needs put into the notification.

Preferably, the notification body that is sent to the WebHook URL of the communication platform is a data structure in JSON format, but may also be in a different data format as long as applicable to the WebHook technology. One example of a notification body to be transmitted to the WebHook URL of the communication platform may look like:

```
{
  “create time”: “xx”,
    “event type”: “gift_request_link created”,
    “resource_type”: “notification”,
    “resource”: {
      “for”: “second identifier”,
      “title”: “some name here has made a gift for
you !”,
      “message”: “Hello !\\nsome name here has made a
gift for you!\\nPlease confirm your contact details and
the consent to receive the gift:\\nMake and receive real
gifts with this service!”,
      “giver name”: “user”,
      “recipient name”: “other user”,
      “gift_request”: “123456789”,
      “links”: {
        “store”: http://store.service.yougiver.me?num-
ber=123456789%recipient=1
      }
    }
  }
```

As can be derived, this notification is sent via the WebHook to the communication platform in case the predefined process is to create an event type in which the presentee is to be notified via the communication platform to be selected for receiving a gift by a user of the communication platform, and is asked in the message presented to indicate the contact details, e.g. including the location data, if not registered yet with the communication platform. For doing so, the notification includes a link which is a so called store link for a web address of the service, which is automatically called when the notification is presented to the user, at which e.g. form the presentee is to enter the requested data. This facilitates augmenting a behaviour of the digital communication platform, in particular of its webpage, e.g. in order to display the additional location data request to the presentee. The format of the WebHook may be JSON. The notification signal may be a HTTP message according to the POST method. In particular, the predefined request and the second identifier are comprised in the body of the message. Such implementation via WebHooks allows a modification and management of the webpage behaviour by a third party, e.g. a developer or the service provider.

In an embodiment, the device comprises the database. In particular, the database comprises the database entries, which e.g. represent a catalogue of gifts. An identifier representing a second computing device, i.e. in particular the device of the seller, is advantageously assigned to each database entry. Further, the control unit is configured to retrieve from the database the identifiers approved for the location data or the subset thereof, and to retrieve all database entries assigned to the location based approved identifiers. This means that the database entries, i.e. the catalogue of gifts, may be filtered according to the location data, e.g. the address of the presentee. Additionally, the database entries, i.e. the gifts may be filtered by a recipients wish list in which the recipient/presentee has selected a subset of the available database entries into the desired ones for a gift. Advantageously, only database entries related to a seller or delivery operator that is approved for the presentee's address and/or the presentee's wish list are retrieved. Further, the control unit is advantageously configured to transmit the trigger signal to the second computing system that is assigned to the selected database entry.

In an advantageous embodiment, the control unit is configured to transmit the response signal excluding the identifier representing the second computing device. This means that the giver is not informed about the seller. In particular, the complete information about the triggering of a process, i.e. the identities of giver, presentee and seller, is only available to the service provider, i.e. the operator of the device. For the giver, this makes triggering the process simple since he only needs to communicate with the service provider, and in particular he only needs to operate within the digital communication platform.

Similarly, the control unit may be configured to transmit the trigger signal to the second remote computing device excluding the first identifier. This means that the identity of the giver is not available to the seller. On the other hand, once the seller not knowing the identity of the giver he cannot disclose this data to the presentee either. This provides additional protection for the sensitive data of the presentee.

According to a second aspect, embodiments of the invention relate to a system for triggering a process. The system comprises a device as described above and the database comprising the database entries. All features described in regard of the device also pertain to the system.

In an advantageous embodiment, the system comprises the first remote computing device and a server computing system representing the communication platform. The server computing system is advantageously configured to transmit a web link representing the request signal to the first remote computing device in response to the user represented by the first identifier being logged on to the communication platform and in response to the second n identifier being selected by the user represented by the first identifier. The web link comprises an address of the device as recipient of the request signal. This facilitates the triggering of the process by the user, i.e. the giver, from within the communication platform, i.e. without the need to visit any further website.

Further, in response to receiving the notification signal from the device, the server computing system may be configured to present the web link to the first or the second identifier within the communication platform, subject to which identifier is included in the notification signal. In particular, the presenting may include transmitting the web link to the second identifier at least when being logged on to the communication platform.

According to a third aspect, embodiments of the invention relate to a computer-implemented method for triggering a process. The method comprises the steps of
receiving a trigger signal from a first remote computing device. The trigger signal requests the triggering of the process, includes a first identifier representing a registered user of a digital communication platform, and includes a second identifier representing another registered user of the digital communication platform.
retrieving from a database a set of database entries subject to location data or a subset thereof assigned to the second identifier;
transmitting a response signal to the first remote computing device. The response signal includes the set of database entries;
receiving a confirmation signal from the first remote computing device. The confirmation signal includes a selection of a first database entry from the retrieved set of first database entries;
transmitting a trigger signal to a second remote computing device assigned to the selected database entry for triggering the process. The trigger signal includes the selected database entry and the location data.

All features disclosed in the context of the device are also meant to be disclosed with regard to the method.

A further aspect of the invention relates to a computer program element which comprises computer program code executing the steps of the above method when executed on a control unit of a computer system.

As a measure of proximity between the location data assigned to the second identifier and the location data of the seller, GPS coordinates representing the two locations may be use, e.g. for a comparison.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a schematic drawing of a computing device as well as a first remote computing device and a second remote computing device interacting according to an embodiment of the invention.

FIG. 2 shows a schematic drawing of a computing device and a server computing system interacting with a first remote computing device and/or with a third remote computing device according to an embodiment of the invention.

FIG. 3 shows a flow diagram of a method according to a first use case of the invention.

### MODES FOR CARRYING OUT THE INVENTION

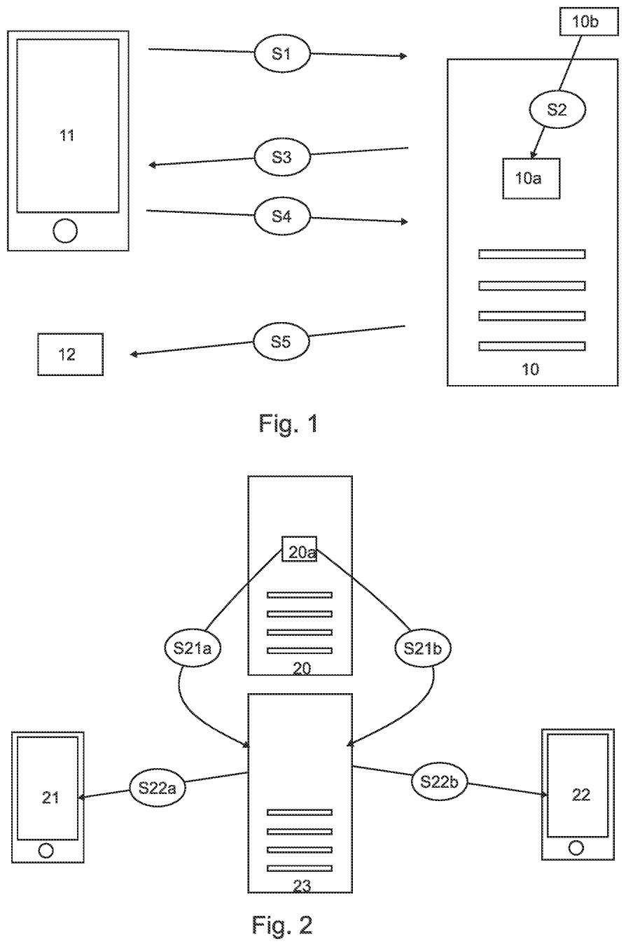

FIG. 1 shows a computing device 10 with a control unit 10a, a first remote computing device 11, e.g. a smartphone or computer of the giver, and a second remote computing device 12, e.g. a server computer of the seller, interacting with each other, i.e. transmitting and receiving signals between each other. A first registered user of a digital communication platform, e.g. a social media platform or a messenger, intends to send a gift, which may e.g. be a good or service, to a second user of the digital communication platform. The first user, i.e. the giver, uses the first remote computing device 11 and is identified through a first identifier in the digital communication platform, e.g. a user name or number. The second user, i.e. the presentee, uses a third remote computing device (not shown in FIG. 1) and is identified through a second identifier in the digital communication platform.

According to an embodiment of the invention, the computing device 10, in particular the control unit 10a, receives a request signal from the first remote computing device 11 in step S1. The request signal requests the triggering of the process, i.e. the delivery of the gift. The request signal further contains the first identifier and the second identifier. In step S2, the control unit 10a retrieves a catalogue of gifts, i.e. a set of database entries, from a database 10b depending on the address, i.e. location data, of the presentee. The database 10b advantageously is an address book of the digital communication platform, which may in particular be private, i.e. not visible to the registered users, in particular not visible to the giver.

In general, the retrieval of the catalogue of gifts may be based on the availability of the different gifts at or proximity to the location of the presentee. As a measure of proximity GPS coordinates and/or the exact address of the presentee's and of the seller's may be n used. Alternatively, the catalogue of gifts may only contain gifts that are available from a seller located in the same country or in the same city as the presentee's address.

In step S3, the catalogue of gifts filtered by the presentee's address is presented to the giver. To achieve this, the control unit 10a transmits a response signal, which includes the catalogue of gifts, to the first remote computing device 11. The giver may then select one or more gifts from the catalogue. Then, the control unit 10a receives a confirmation signal including the selected one or more gifts from the giver in step S4.

In step S5, the control unit 10a transmits a trigger signal to the second remote computing device 12, e.g. a server system of the seller, which is attributed to the selected gift. Thus, the seller receives all information necessary to process the order and to deliver the gift to the presentee. For that purpose, the trigger signal comprises the selected gift as well as the presentee's address.

For the giver, the whole process with steps S1 to S5 above may in general be performed from within the digital communication platform. This means the giver, i.e. the first registered user, is logged on to the platform, and all necessary information such as the catalogue of gifts is displayed to the giver within the platform. In particular, the triggering of the process in step S1 may be implemented as an icon or an order text or symbol displayed in connection with another registered user, e.g. with the presentee, i.e. the second registered user. In one example, such icon may be presented in the address book of the platform, specifically in every entry of the address book in order to first select the presentee from the address book, and then klick on the icon representing the trigger for the process. In a different approach, such icon is displayed at some instance of the platform. When clicking on such icon, the address book of the platform

FIG. 2 schematically shows how such communication of the computing device 20 with the giver, in particular with the first remote device 21, and/or with the presentee, in particular with the third remote device 22, may be implemented through a server computing system 23 representing the digital communication platform. The notification signal transmitted by the control unit 20a of the device 20 includes the first identifier and/or the second identifier for communicating with the first remote device 21 and/or the third remote device 22, respectively. Further, the notification signal requests the server computing system 23 to present a predefined request to the first identifier and/or to the second identifier, respectively. Advantageously, such request is presented to the giver and/or to the presentee as a message, e.g. comprising pictures such as in the case of the catalogue of gifts, or as a form to-be-filled. In particular, the request comprises a web link or web address of the device 20 such that the server computing system 23 may respond to the predefined request, e.g. by transmitting the filled-in form.

Such implementation of the communication when triggering the process is very user-friendly. It enables the giver to send a gift to the presentee without knowing the latter's address or any other of its data. This is in contrast to existing platforms of gift-giving and e-commerce wherein the giver needs to know and to fill in the address of the presentee. With an implementation of the triggering of the process according to the invention, entirely new uses cases are possible and new circles of customers may be reached, e.g. by a gift shop or flower shop. As such, the current implementation enables also new business models.

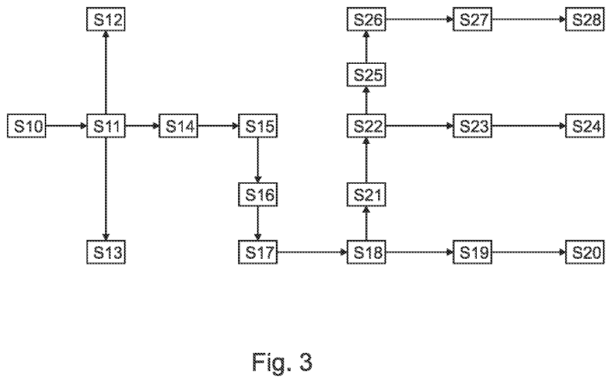

FIG. 3 shows a use case of triggering the n process, in particular the delivery of the gift that may be implemented according to embodiments of the invention.

Firstly, FIG. 3 concerns a first use case wherein all necessary address data of the presentee is filled, i.e. available to the computing device, in particular through an address book of the digital communication platform. In step S10, the formation of the delivery order is started, e.g. by the giver clicking on a button or icon presented within the communication platform for sending a gift to the presentee which click results in a request signal transmitted to the device. The control unit of the device receives such request signal. In step S11, the control unit examines the address data available for the second identifier, i.e. for the presentee, e.g. in the address book of the digital communication platform or in an own address database of the device. If the available address of the presentee is complete, i.e. if it enables a delivery of the gift to the presentee, then the control unit continues with step S14. If only the presentee's country and city are available, then the control unit continues with steps S12, i.e. it jumps to the second use case, see below. If the presentee's address is not available at all, in particular not even country and city, then the control unit continues with step S13, i.e. it jumps to the third use case, see below.

In step S15, the control unit retrieves the catalogue of gifts that are available in the presentee's city or country and/or that are preselected by the presentee. The catalogue is then presented to the giver who selects one or more gifts for delivery to the presentee. In step S16, the giver is requested to make a payment of an amount depending on the one or more selected gifts. The payment process itself may, in general, be outsourced to a dedicated payment service, e.g. by communication between the device and a payment server. As a result, the amount is blocked for payment on the giver's account or credit card before order confirmation by either the presentee or the seller. In step S17, the optional step of sending a notification to the presentee for confirming the receipt of the gift. The recipient may indicate in his profile one of the two options “confirm receipt of each gift”, “confirm receipt of a gift from everyone except the specified list of people” or “do not confirm receipt of each gift” and in this case such confirmation will not be required.

In step S18, the response of the presentee is received. If it is negative, i.e. if the presentee refuses to receive the gift, a notice is sent to the giver in step S19, e.g. saying that the presentee refused to receive the gift. Further, the order is closed in step S20 since it was not confirmed by the presentee. If the response received in step S18 is positive, i.e. the presentee confirms her willingness to receive the gift, then the trigger signal is sent to the seller and the payment is effected, in step S21. In step S22, the seller may decide if he accepts the order. If not, then the order is closed in step S23 as rejected by the seller. Further, a notification is sent to the giver in step S24, e.g. saying that the seller rejected the order, and the blocked amount is unlocked. If the seller accepts the order in step S22, the amount is paid from the account of the giver in step S25. Then, the seller completes the order in S26, i.e. he delivers the gift to the presentee's address. When completed, a notification is sent to the giver that the gift has been delivered to the presentee in step S27. Further, the order is closed in step S28 as successfully completed under the first use case.

The second use case concerns the case when n not the complete address of the presentee is available but at least the country and/or city are filled. The second use case is very similar to the first one as described with respect to FIG. 3. A difference exists in step S17 when a notification is sent to the presentee for confirming the receipt of the gift. In the second use case, such notification additionally comprises a request to add missing address data, e.g. a street and house number or postbox of the presentee. If the presentee confirms her willingness to receive the gift and adds the missing address data, then the process continues with step S21. Otherwise, it ends with steps S19 and S20.

In an alternative to the second use case, the country and/or city of the presentee may not be available from a database of the digital communication platform or of the service provider. However, the giver knows the country and/or city of the presentee. For such case, step S14 additionally comprises an option that the giver fills in the country and/or city of the presentee. This means that the request signal received by the control unit not only comprises the first identifier, i.e. the giver, and the second identifier, i.e. the presentee, but also the presentee's country and/or city as part of the address. Then, the process continues with step S15 as in the second use case.

The third use case concerns the case when the city and/or country of the presentee are not available. Also the third use case is similar to the first one as described with respect to FIG. 3. However, it is necessary in the third use case that the missing address data of the presentee is added before the formation of the catalogue of gifts in step S15 since the catalogue of gifts depends on e.g. the county and/or the city of the presentee. This means that according to the third use case, a notification is sent to the presentee in step S14 for confirming to receive a gift, in particular a gift n which is not yet selected by the giver. At the same time, this notification comprises a request to add the missing address data. If no confirmation is received or if the address data is not completed, then the process ends after continuing with steps S19 and S20. If the confirmation and the address data is received, then a notification is sent to the giver that the order process may be continued, in particular the notification comprising the catalogue of gifts as retrieved in step S15 depending on the presentee's address. Another notification to the presentee for confirming to receive a gift as in step S17 according to the first or the second use case is not necessary in the third use case. This means that step S17 may be omitted in the third use case.

Preferably, a waiting time for confirmation from the recipient/presentee is set in the system. It can be, for example, 48 hours or any other value. If the recipient does not confirm receipt of the gift at the indicated time, the order is automatically canceled. This is also due to protection against price changes.

The previous embodiments are particularly concerned with the situation where both, giver and presentee, are registered users of the digital communication platform. However, there may be cases where e.g. the presentee is not a user of the digital communication platform. According to a fourth use case, the giver may then transmit a request requesting the creation of a link to the device, in particular the first identifier being attributed to the link. The device then creates such link, attributes the first identifier representing the giver to the link and sends the link to the giver. The giver makes the link available to the presentee. If the presentee follows the link, she is asked to confirm to receive a gift and to fill in her address data as in the third use case. This means the process continues with step S14 of the third use case. As in the third use case, another notification to the presentee for confirming to receive a gift is not necessary, meaning that step S17 may be omitted in the third use case.

The fourth use case has the advantage that it is flexible in terms of the digital communication platform used. While the giver may trigger the process from any platform that implements the triggering service as described above, the presentee does not even need to be a user of the platform. This facilitates a widening of circle of presentees, i.e. a gift may be sent to anyone having access to an internet-capable device such as the third remote device.

According to a fifth use case, the giver may also fill in the presentee's address himself. While such use case may be performed by conventional online stores, it may also be implemented with embodiments of the present invention. The latter steps concerning the formation of the catalogue of gifts, the payment, the communication with the sender and the final notification to the sender can be implemented as in the third and fourth use case, i.e. from step S15 onwards, the process is the same. However, the start of the process is different.

If the giver knows the complete address of the presentee, he may select an option such as “I want to send a gift and know all the data of the presentee”. Upon receiving such request option, the control unit sends a fill-in form for the presentee's address to the giver. When the complete address data of the presentee is received, the control unit continues with step S15 as in the third and the fourth use case. Again, a confirmation of the presentee expressing her willingness to receive the gift as in steps S17 of FIG. 3 may not be necessary in the fifth use case, in particular if a classical online purchase scenario is implemented. Nevertheless, step S17 may optionally be implemented, too, in order not to take the presentee by surprise or to give her the n chance to refuse the selected gift.

As is understood from the above, embodiments of the invention facilitate a new way of triggering a process, in particular a delivery process where the address of the presentee is not known and remains unknown to the giver. Features disclosed with respect to the device are meant to be disclosed with respect to the method as well, and vice versa. The method steps described above may be rearranged and combined in various ways to implement embodiments of the invention.

While there are shown and described presently preferred embodiments of the invention, it is to be distinctly understood that the invention is not limited thereto but may be otherwise variously embodied and practiced within the scope of the following claims.

1. Computing device for triggering a process, comprising
a control unit configured to receive a request signal from a first remote computing device, the request signal
requesting the triggering of the process,
including a first identifier representing a registered user of a digital communication platform,
including a second identifier representing another registered user of the digital communication platform,
wherein the control unit is configured to retrieve from a database a set of database entries subject to location data or a subset thereof assigned to the second identifier,
wherein the control unit is configured to transmit a response signal to the first remote computing device, the response signal including
the retrieved set of database entries,
wherein the control unit is configured to receive a confirmation signal from the first remote computing device, the confirmation signal including
a database entry selected from the retrieved set of database entries, and
wherein the control unit is configured to transmit a trigger signal to a second remote computing device assigned to the selected database entry, for triggering the process, the trigger signal including
the selected database entry, and
the location data and/or data assigned to the second identifier.

2. Device for triggering an process according to claim 1,
wherein the control unit is configured to receive the request signal additionally including the location data or a subset thereof assigned to the second identifier, and
wherein the control unit is configured to, in response to receiving the request signal, retrieve the set of database entries from the database subject to the location data comprised in the request signal.

3. Device for triggering a process according to claim 1,
wherein the control unit is configured to, in response to receiving the request signal, transmit a counter request signal to the first remote computing device, the counter request signal
requesting for the location data or a subset thereof assigned to the second identifier,
wherein the control unit is configured to receive location confirmation signal from the first remote computing device, the further request signal
including the location data or the subset thereof assigned to the second identifier,
wherein the control unit is configured to retrieve the subset of database entries from the database in response to the location confirmation signal received from the first remote computing device.

4. Device for triggering a process according to claim 2,
wherein the control unit is configured to, in case the request signal or the only including the subset of location data or no location data, transmit, in response to receiving the confirmation signal, a notification signal to a server computing system representing the communication platform, the notification signal
including the second identifier, and
requesting the server computing system to present an additional location data request to the second identifier, and including triggering the server computing system to automatically present the additional location data request to the second identifier,
wherein the control unit is configured to receive an additional signal from a third remote computing device, the additional signal
including the additional location data, and
wherein the control unit is configured to, in response to receiving the additional signal, transmit the trigger signal to the second computing device.

5. Device for triggering a process according to claim 4,
wherein the additional location data request in the notification signal includes a web link to a web address of the device.

6. Device for triggering a process according to claim 1,
wherein the control unit is configured to transmit a notification signal to a server computing system representing the communication platform, the notification signal
including the first identifier, and
requesting the server computing system to present a predefined request to the user represented by the first identifier, and including triggering the server computing system to automatically present the predefined request to the user represented by the first identifier,
wherein the predefined request in the notification signal includes a web link to a web address of the device.

7. Device for triggering a process according to claim 1,
wherein the control unit is configured to transmit a notification signal to a server computing system representing the communication platform, the notification signal
including the second identifier, and
requesting the server computing system to present a predefined request to the other user represented by the second identifier, including triggering the server computing system to automatically present the predefined request to the other user represented by the second identifier,
wherein the predefined request includes a web link to a web address of the device.

8. Device for triggering a process according to claim 1,
the digital communication platform allowing digital communication between registered users by means of identifiers representing the registered users,
the device comprising a memory for storing identifiers of registered communication platforms,
wherein the request signal includes an identifier for the communication platform the user makes use of when initiating the request signal,
wherein the control unit is configured to store a combination of the identifier of the communication platform, the first identifier and the second identifier,
wherein the control unit is configured to assign a processing identifier representing the requested process to at least the combination of the identifier of the communication platform, the first identifier and the second identifier, and to store the processing identifier,
wherein the control unit is configured to assign and store the location data in combination with the second identifier.

9. Device for triggering a process according to claim 1,
wherein the first identifier represents an originator of the request signal as identified in the digital communication platform and at the same time represents the user of the first remote computing device at the time the request signal is initiated, and
wherein the second identifier represents a recipient of the triggered process as identified in the digital communication platform.

10. Device for triggering a process according to claim 1,
wherein the control unit is configured to ban the location information and/or other data of the other user to become retrievable or visible to the user represented by the first identifier.

11. Device for triggering a process according to claim 1,
wherein the device is another server computing system, and includes a web server computing system,
wherein the control unit of the device includes one or more hardware processors and software configured to implement the assigned functions,
wherein the request signal is a hypertext transfer protocol message according to the POST method,
wherein the first identifier and the second identifier are comprised in the body of the message.

12. Device for triggering an process according to claim 4,
wherein the control unit is configured to transmit the notification signal via WebHooks, and
wherein the notification signal is a hypertext transfer protocol message according to the POST method,
wherein the predefined request and the second identifier are comprised in the body of the message.

13. Device for triggering an process according to claim 1,
comprising the database,
wherein an identifier representing a second computing device is assigned to each database entry,
wherein the control unit is configured to retrieve from the database the identifiers approved for the location data or the subset thereof, and to retrieve all database entries assigned to the location based approved identifiers,
wherein the control unit is configured to transmit the trigger signal to the second computing device that is assigned to the selected database entry,
wherein the control unit is configured to transmit the response signal excluding the identifier representing the second computing device.

14. Device for triggering a process according to claim 1,
wherein the control unit is configured to transmit the trigger signal to the second remote computing device excluding the first identifier.

15. System for triggering a process, comprising
a device according to claim 1, and
the database.

16. System according to claim 15, comprising
the first remote computing device, and
a server computing system representing the communication platform,
wherein the server computing system is configured to offer a web link representing the request signal to the first remote computing device, which web link comprises an address of the device as recipient of the request signal, in response to the user represented by the first identifier being logged on to the communication platform and in response to the second identifier being selected by the user represented by the first identifier.

17. System according to claim 16,
wherein the server computing system is configured to, in response to receiving a notification signal from the device, to present the web link to the first or the second identifier within the communication platform, subject to which identifier being included in the notification signal,
wherein the presenting includes transmitting the web link to the first or second identifier respectively at least when being logged on to the communication platform.

18. Computer-implemented method for triggering a process,
comprising the steps of receiving a trigger signal from a first remote computing device, the trigger signal
requesting the triggering of the process, and
including a first identifier representing a registered user of a digital communication platform,
including a second identifier representing another registered user of the digital communication platform,
retrieving from a database a set of database entries subject to location data or a subset thereof assigned to the second identifier,
transmitting a response signal to the first remote computing device, the response signal including
the set of database entries,
receiving a confirmation signal from the first remote computing device, the confirmation signal including
a selection of a first database entry from the retrieved set of first database entries,
transmitting a trigger signal to a second remote computing device assigned to the selected database entry for triggering the process, the trigger signal including
the selected database entry, and
the location data and/or data assigned to the second identifier.

19. Computer program element comprising computer program code executing the steps of the method of claim 18 when executed on a control unit of a computer system.
